(19) United States
(12) Patent Application Publication
(10) Pub. No.: US 2002/0038322 A1
(43) Pub. Date: Mar. 28, 2002

(54) Information processing apparatus, method therefor,and computer-readable memory

(76) Inventor: Keiko Iijima, Kanagawa (JP)

Correspondence Address: FITZPATRICK CELLA HARPER & SCINTO, 30 ROCKEFELLER PLAZA, NEW YORK, NY, 10112, US

(21) Appl. No.: 09/956,791

(22) Filed: Sep. 21, 2001

(30) Foreign Application Priority Data
Sep. 26, 2000 (JP) 2000-292928

(51) Int. Cl. G06F 15/00

(52) U.S. Cl. 707/526; 707/515

(57) ABSTRACT

Electronic source documents of a plurality of types are retained and a electronic-binder builder selects a desired electronic source document page from electronic source document pages of the plurality of kinds of electronic source documents held. The electronic-binder builder composes an integrated electronic document based upon the electronic source document pages selected. A thumbnail image that corresponds to the electronic source document page that constitutes the built integrated electronic document is displayed. Information, which relates to the electronic source document page that corresponds to the thumbnail image, is displayed in the vicinity of the thumbnail image based upon an operation with respect to the thumbnail image displayed.

### FIELD OF THE INVENTION

The present invention relates to an information processing apparatus for composing an integrated electronic document from a plurality of kinds of electronic source documents, a method therefor, and a computer-readable memory.

### BACKGROUND OF THE INVENTION

Business entities try to promote reuse of documents by introducing a document management system. Products at early stage receive a paper document as an image using a scanner and registers and saves the image. Recently, many electronic documents are created by personal computers, and even they can also be registered and saved. In addition, recently, arbitrary pages can be extracted from a plurality of registered electronic documents and bound like a binder to form one electronic document. This will be referred to as an electronic binder hereinafter.

To realize such an electronic binder, conventionally, a plurality of different electronic documents are temporarily converted into a unitary electronic document format, and the converted electronic documents are edited to compose a desired generated electronic document. In this method, new electronic documents, which are completely separated from electronic source documents as materials, are edited to compose a generated electronic document. When the electronic source documents are changed, the changed electronic source documents are temporarily deleted from the generated electronic document, and then the changed electronic source documents are input again. If the degree of editing is high, a considerable labor for delete, move, and the like or many errors occur. In addition, when an electronic binder is stored and displayed at a terminal such as a personal computer, information concerning the electronic source documents of each page constituting the binder is not obtained. As described above, if a material and generated document are completely separated, a labor is required to restore the original document.

### SUMMARY OF THE INVENTION

The present invention has been made in consideration of the above situation, and has as its object to provide an information processing apparatus capable of creating one integrated electronic document from a plurality of different electronic source documents and easily ascertaining the relationship between the electronic source documents and the integrated electronic document, a method therefor, and a computer-readable memory.

According to the present invention, the foregoing object is attained by providing an information processing apparatus for composing an integrated electronic document composed of a plurality of kinds of electronic source documents, comprising:

holding means for holding the plurality of kinds of electronic source documents;

selection means for selecting a desired electronic source document page from electronic source document pages of the plurality of kinds of electronic source documents held by said holding means;

composition means for composing the integrated electronic document on the basis of the electronic source document page selected by said selection means;

display means for displaying a thumbnail image that corresponds to the electronic source document page that constitutes the integrated electronic document composed by said composition means; and

display control means for displaying information, which relates to the electronic source document page that corresponds to the thumbnail image, in the vicinity of the thumbnail image based upon an operation with respect to the thumbnail image displayed by said display means.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

FIG. 1 is a view showing the concept of a document management system according to an embodiment;

FIG. 2A is a view showing the format block structure of a generated electronic document composed by an electronic binder builder of the embodiment;

FIG. 2B is a view showing an example of XML description of the generated electronic document composed by the electronic binder builder of the embodiment;

FIG. 3 is a view showing the format block structure of another generated electronic document composed by the electronic binder builder of the embodiment;

FIG. 4 is a view showing the arrangement of folders and files of the generated electronic document of the embodiment;

FIG. 5 is a view showing operation windows related to processing of the electronic binder builder of the embodiment;

FIG. 6 is a flowchart showing display processing executed according to the embodiment;

FIG. 7 is a diagram illustrating examples of thumbnail images of constituent pages and of icons of applications that created the thumbnail images;

FIG. 8 is a diagram illustrating examples of thumbnail images of constituent pages, document names of material documents and page numbers of material documents; and

FIG. 9 is a block diagram showing the arrangement of an information processing apparatus applicable to the document management system of the present invention.

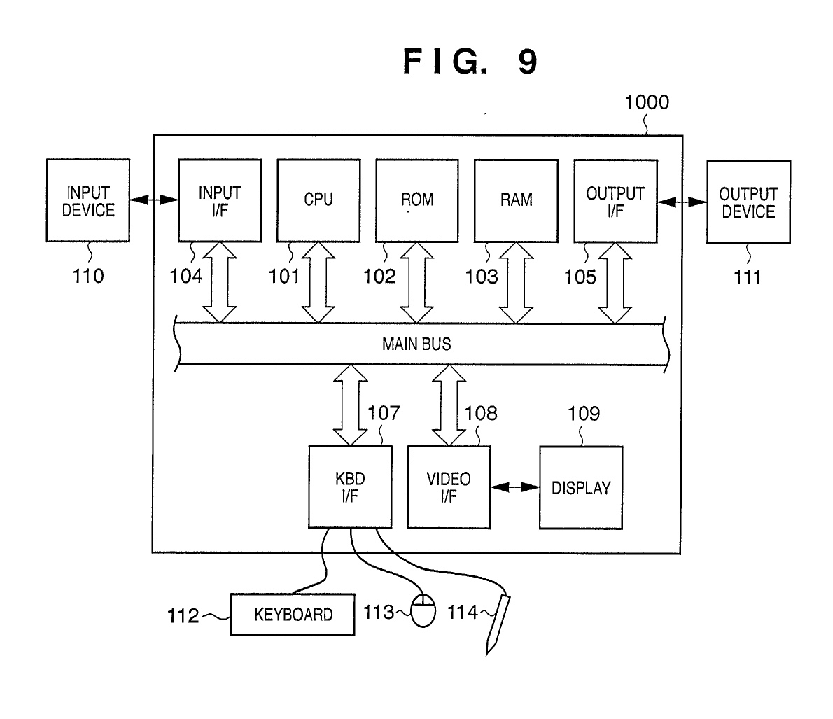

### DESCRIPTION OF THE PREFERRED EMBODIMENT

Preferred embodiments of the present invention will be described below in detail with reference to the accompanying drawings.

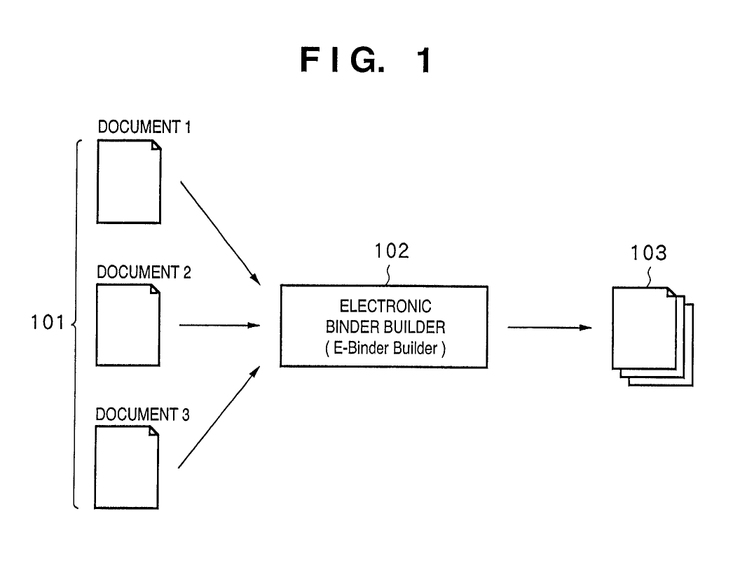

FIG. 1 is a view showing the concept of a document management system according to an embodiment.

Referring to FIG. 1, reference numeral 101 denotes electronic documents created by different application software programs. Assume that the electronic documents include electronic document 1 created by Microsoft Word, electronic document 2 created by Microsoft PowerPoint, and electronic document 3 having an HTML format which is used by an image read with a scanner or in the Internet. An electronic binder builder (e-binder builder) 102 can bind pages of the electronic documents 1 to 3 to compose one generated electronic document 103.

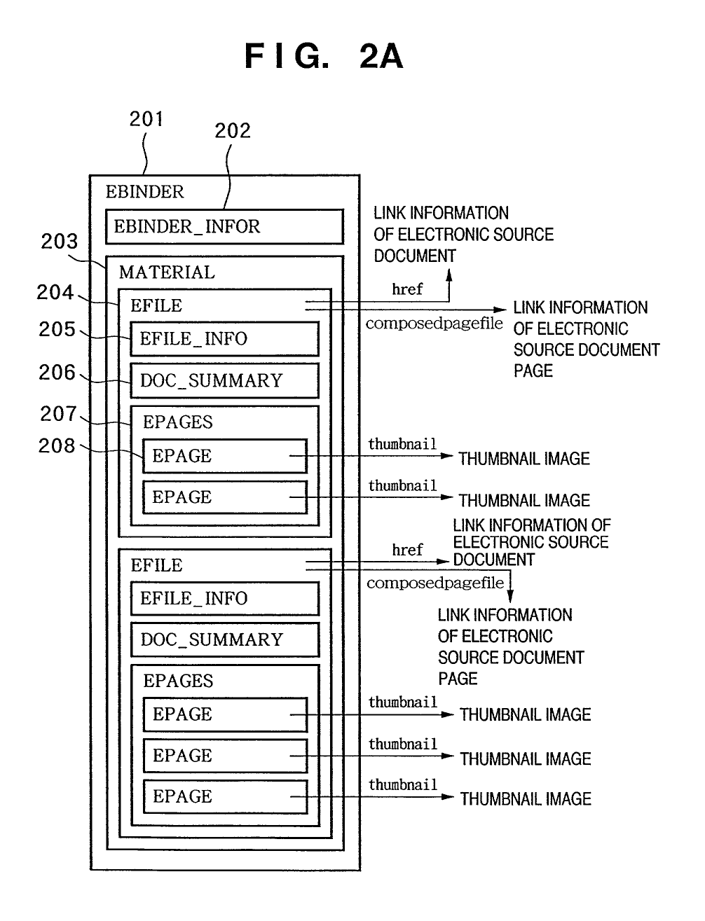

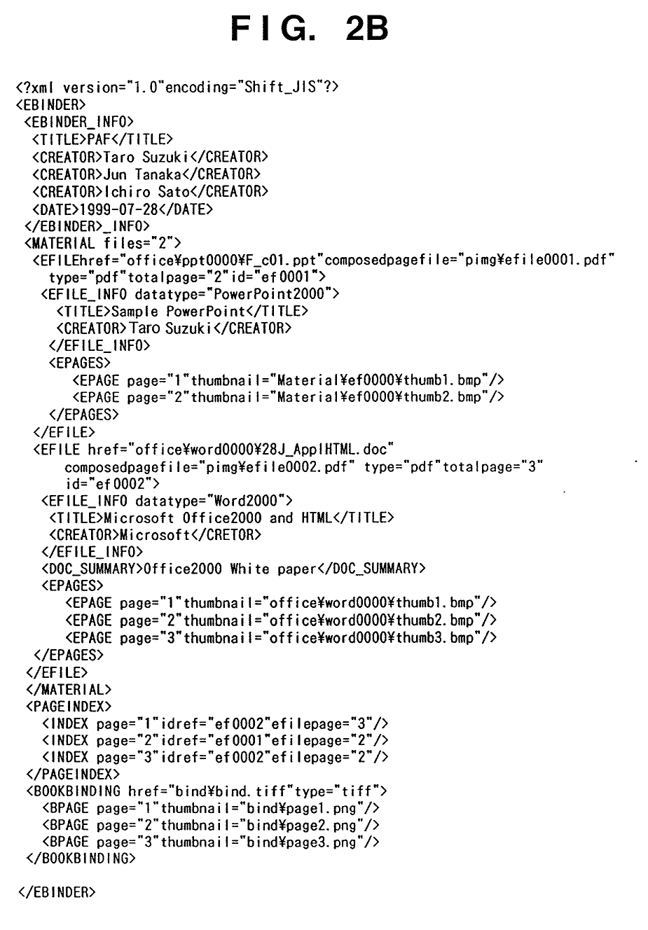

An example of the generated electronic document composed by the electronic binder builder 102 of the document management system of this embodiment will be described next with reference to FIGS. 2A and 2B.

FIG. 2A is a view showing the format block structure of a generated electronic document composed by the electronic binder builder of the embodiment, and FIG. 2B is a view showing a detailed example of XML description thereof.

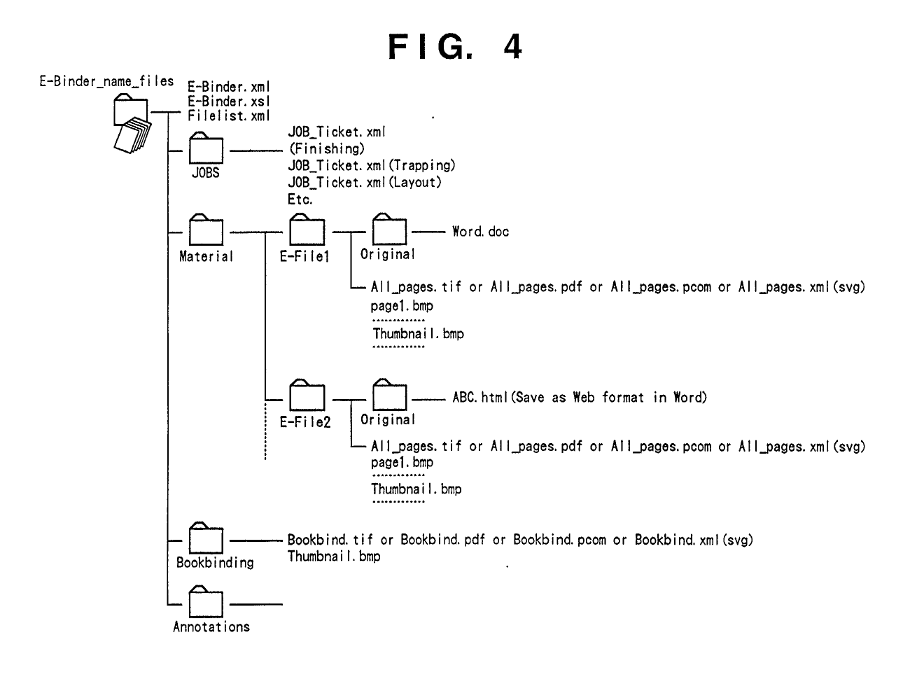

In the present invention, a generated electronic document is composed using an XML (extensional Markup Language) description. A generated electronic document is composed of a plurality of kinds of electronic source documents created by different application software programs. As the basic composition, a document E-Binder.xml is formed as a Top description, a predetermined description is done therein, and elements (contents) such as relational files are indicated by external link. The locations of the elements indicated by the external link must be known. FIG. 4 shows the arrangement of folders and files of the generated electronic document. The holding positions of the external link elements can be known as relative positions from E-Binder.xml as the Top document.

Referring to FIG. 2B, <?xml version=“1.0” encoding=“Shift_JIS”?> is the description of declaration at the start.

An EBINDER portion (201) in FIG. 2A indicates the start of the document. A portion between <EBINDER> and </EBIDNER> in FIG. 2B is the main body of the document.

An EBINDER_INFOR portion (202) in FIG. 2A is a portion that holds the meta information (management information) of the document. A portion between <EBINDER_INFO> and </EBINDER INFO> holds the meta information. Especially, pieces of meta information <TITLE> to </TITLE> representing the file name, <CREATOR> to </CREATOR> representing the creator name, and <DATE> to </DATE> representing the date of creation are held here.

A MATERIAL portion (203) in FIG. 2A is a portion that holds the information of electronic source documents. A portion between <MATERIAL files=“2”> and </MATERIAL> holds the information, in which files=indicates the number of electronic source documents, and two files are held here.

An EFILE portion (204) in FIG. 2A is a portion that holds the information of one electronic source document, i.e., the information obtained by converting an electronic source document into electronic document pages. A portion between <EFILE href=“office¥ppt0000¥F_c01.ppt” composedpagefile=“pimg¥efile0001.pdf” type=“pdf” totalpage=“2” id=“ef0001”> and </EFILE> holds the information. Hereinafter, “¥” corresponds to “\” (backslash). Here, href= indicates the link information of the electronic source document, composedpagefile= indicates the link information of a file in which the pages of the electronic source document are put together, and type= indicates the file format. In this example, the PDF format of Adobe is indicated. Alternatively, MultiPageTIFF or the like, that is a format capable of storing a plurality of images, can be set. In addition, totalpage= indicates the number of pages of the electronic source document, and id= indicates the identification number.

An EFILE_INFO portion (205) in the EFILE portion (204) shown in FIG. 2A holds the management information of an electronic source document. A portion between <EFILE_INFO datatype=“PowerPoint2000”> and </EFILE_INFO> holds the management information. In this case, datatype= indicates the type of the electronic source document, which represents PowerPoint2000. <TITLE> to </TITLE> representing the file name and <CREATOR> and </CREATOR> representing the creator name hold the management information.

A DOC_SUMMARY portion (206) in FIG. 2A holds the summary information of an electronic source document. This portion holds a text obtained by summarizing a full text using a summarizing engine so that the summary of the material contents can be known. This portion is omitted in FIG. 2B.

An EPAGES portion (207) in FIG. 2A saves documents (electronic source document pages) obtained by changing an electronic source document into information pages. For example, for the electronic source document of Word, pages are determined only in displaying or printing the document. The EPAGES portion (207) saves the determined electronic source document pages. A portion between <EPAGE> and </EPAGE> saves electronic source document pages. Actually, the following <EPAGE . . . /> portion such as <EPAGE page=“1” thumbnail=“Material¥ef0000¥thumb1.bmp”/> or <EPAGE page=“2” thumbnail=“Material¥ef0000¥thumb2.bmp”/> holds an electronic source document page. Here, page= is information representing the ordinal number of a page in the entire electronic source document, and thumbnail= is information that holds the thumbnail image (reduced image) of the page. The next description also indicates the information of the electronic source document page. In this way, the page bitmapping information of an electronic source document (the information of an electronic source document page) is held. The bitmapped document of an electronic source document page, e.g., an image bitmapped to A4 size is also held here.

<EPAGE page=“1”

thumbnail=“Material¥ef0000¥thumb1.bmp”

Pagefile=“office¥ppt0000¥page0001.bmp” type=“bmp”/>

In this example, pagefile= holds the thumbnail image of the first page, and type= indicates the holding file format. In this example, the electronic source document page is held by an image file format “bmp”. However, PDF or any other compression file format may be used. The necessary condition is that each page of a document can be held. The number of <EPAGE . . . /> portions is determined by the number of pages of an electronic source document.

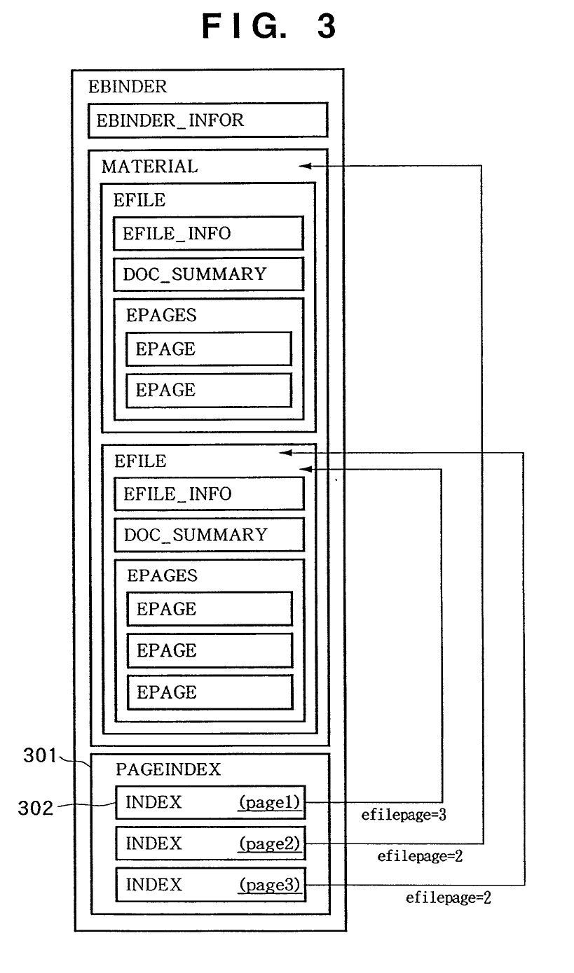

FIG. 3A is a view showing the format block structure of another generated electronic document in which necessary electronic source document pages are selected from electronic source documents and held.

A PAGEINDEX portion (301) in FIG. 3A holds information that indicates the position of each page-bitmapped portion of electronic source documents. For a generated electronic document, the ids and page numbers of electronic source documents are managed, and page images are read out in that order, thereby composing a continuous electronic document. A portion between <PAGEINDEX> and </PAGEINDEX> in the description example shown in FIG. 2B is a description for managing and saving the pages of the generated electronic document. In this portion,

<INDEX page=“1” idref=“ef0002” efilepage=“3”/>

<INDEX page=“2” idref=“ef0001” efilepage=“2”/>

and the like are described. Each <INDEX . . . /> indicates a page of the generated electronic document. Here, page= indicates a page of the generated electronic document, idref= indicates the id of an electronic source document, and efilepage= indicates a page number of the electronic source document corresponding to id. In the above description example, pages separately designated from two electronic source documents are used.

The format block structure of a generated electronic document described above can simultaneously save electronic source documents, electronic source document pages, and generated electronic document. Hence, in editing, the original electronic documents of the electronic source documents can be referred to, and pages can be replaced again. An electronic source document page can be an imaged document or a document in the PDF or XML format. The format can be switched in accordance with the software environment for forming electronic source document pages.

Thus, the electronic-binder builder 102 is software for composing a generated electronic document by selecting electronic source document pages of the necessary pages from electronic source documents of different formats, and for re-editing the generated electronic document. The electronic-binder builder 102 is stored as an electronic document in a format of the kind described thus far. Stored in such documents are thumbnail images corresponding to individual pages of electronic documents, which are the constituent pages, and information relating to the original electronic source documents.

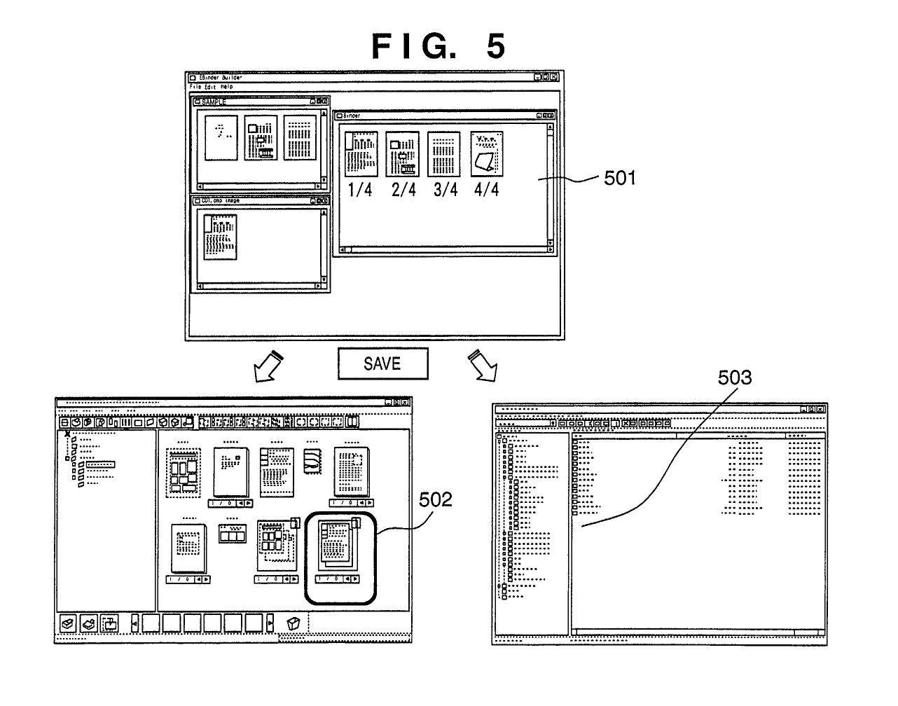

Operation windows related to processing of the electronic binder builder 102 will be described next with reference to FIG. 5.

FIG. 5 illustrates an example of GUIs for storing and displaying an electronic binder that has been created by the electronic-binder builder 102. Numeral 501 denotes an example of a GUI illustrating the manner in which the electronic-binder builder 102 is opened and editing is applied to an electronic-binder document constituting a generated electronic document composed of a plurality of electronic source document pages. Numeral 502 denotes an example of a GUI showing the manner in which a stored electronic-binder document is displayed in the form of a thumbnail image. Numeral 503 denotes an example of a GUI showing the manner in which stored electronic-binder documents are displayed in list form.

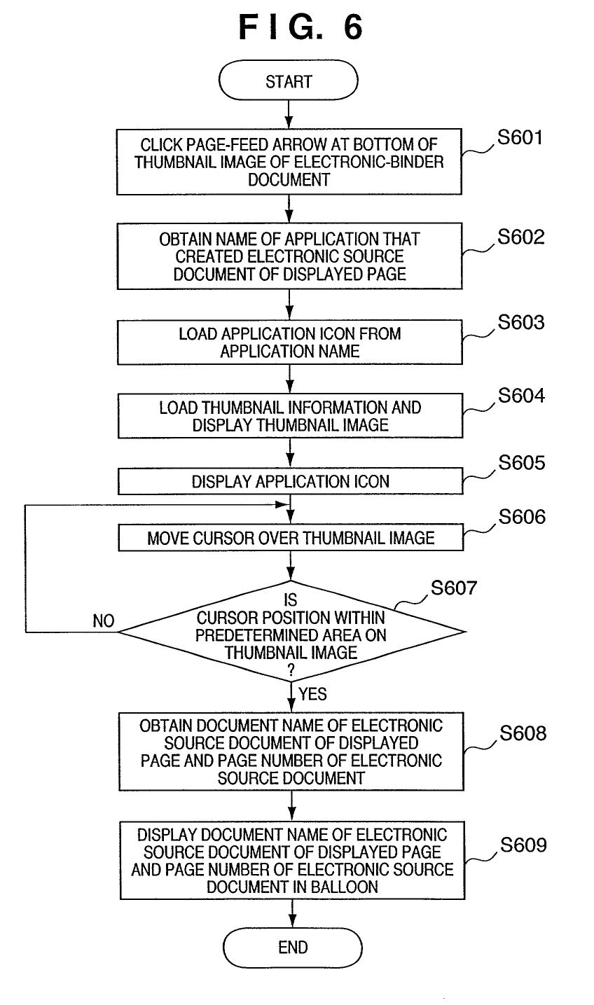

Display processing in accordance with an operation of a thumbnail image corresponding to an electronic source document page constituting electronic-binder documents, will be described next with reference to FIG. 6.

FIG. 6 is a flowchart illustrating display processing executed according to this embodiment.

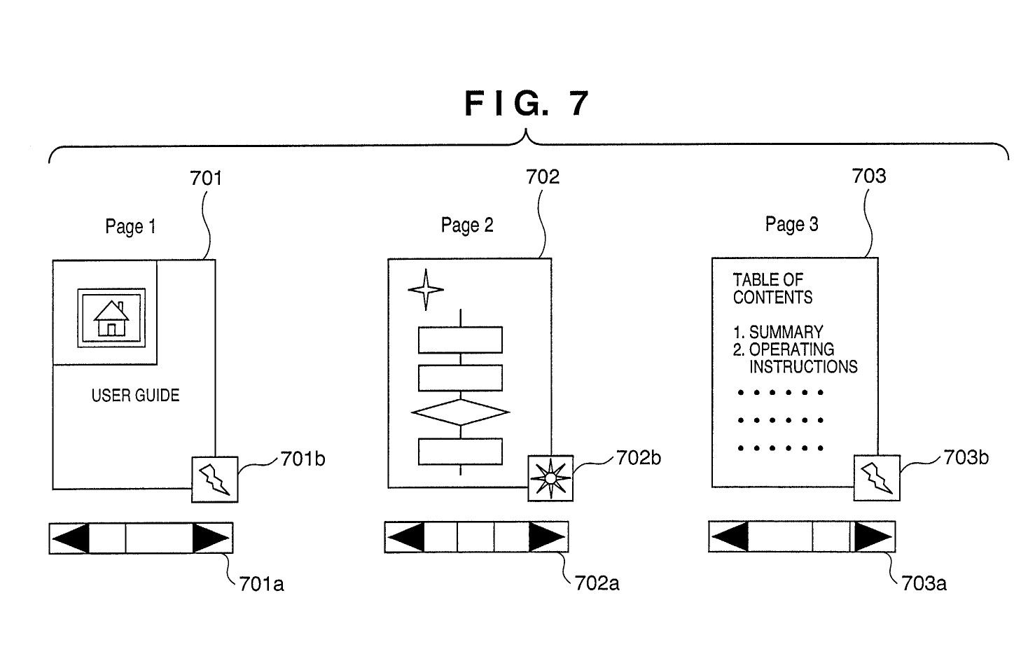

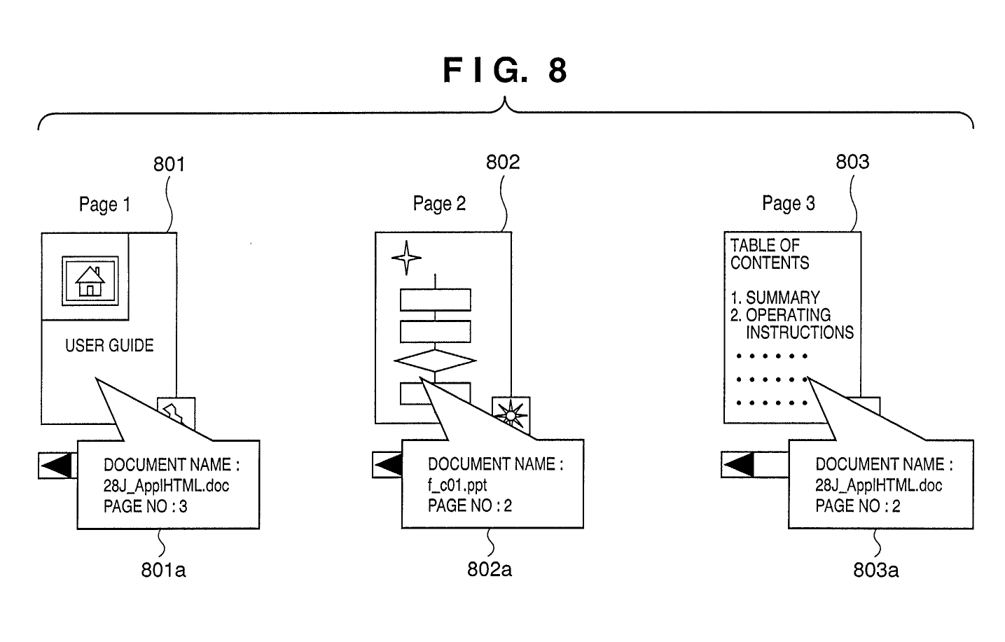

A page is turned at step S601 by clicking a page-feed arrow at the bottom of a thumbnail image of an electronic-binder document. FIGS. 7 and 8 illustrate the transition of the display of the thumbnail image 502, which corresponds to the electronic-binder document of FIG. 5, in a case where the page-feed arrow is clicked. Examples of page-feed arrows 701a to 703a are displayed below thumbnail images 701 to 703 in FIG. 7. Right- and left-pointing page-feed arrows 701a to 703a are provided. If the right-pointing page-feed arrow is clicked, the display of page information shifts from that of the page currently being displayed to that of the next page. If the left-pointing page-feed arrow is clicked, the display of page information shifts from that of the page currently being displayed to that of the previous page.

This is followed by step S602, at which the name of the application used to create the electronic source document page of the displayed page is obtained from the XML coding of the electronic-binder document shown in FIG. 2B. For example, if the first page of thumbnail image 701 in FIG. 7 is changed to the second page of thumbnail image 702 in FIG. 7, the line

<INDEX page=“2” idref=“ef0001” efilepage=“2”/>

within the tag <PAGEINDEX> in the example of FIG. 2B is retrieved. Here page=“2” indicates that this line is information of the second page of the electronic-binder document. The fact that the file of id=“ef0001” is an electronic source document can be analyzed from idref=“ef0001”. Next, the line

<EFILEhref=“office¥ppt0000¥F_c01.ppt”

composedpagefile=“pimg¥efile0001.pdf” type=“pdf”

totalpage=“2”id=“ef0001”>

is retrieved. Here id=“ef0001” indicates that this line is information relating to the electronic source document of the second page of the electronic-binder document.

Next, the line

<EFILE_INFO datatype=“PowerPoint2000”>

is retrieved in tags up to </EFILE>, which indicates the end of information relating to one electronic source document. Here datatype=“PowerPoint2000” indicates this electronic source document was created using the application referred to as PowerPoint 2000.

This is followed by step S603, at which the application icon indicative of this application is loaded from the application name.

Thumbnail information of the displayed page is loaded and the thumbnail image is displayed at step S604. More specifically, thumbnail information relating to the displayed page is obtained from the XML coding of the electronic-binder document exemplified in FIG. 2B. For example, in a case where the first page of thumbnail image 701 in FIG. 7 is changed to the second page of thumbnail image 702 in FIG. 7, it is understood that the second page (efilepage=“2”) of the electronic source document is the second page (page=“2”) of the electronic-binder document from the line

<INDEX page=“2” idref=“ef0001” efilepage=“2”/>

analyzed at step S602. Accordingly, the line <EPAGE page=“2” thumbnail=“office¥ppt0000¥thumb2.bmp”/> between <EPAGES> and </EPAGES>, which is between <EFILE . . . id=“ef0001”> and </EFILE>, is retrieved and it is found by analysis that the thumbnail image of the second page is “office¥ppt0000¥thumb2.bmp”. This file is loaded and is displayed in the manner of thumbnail image 702 in FIG. 7 as the thumbnail image of the second page of the electronic-binder document.

Next, at step S605, the application icon loaded at step S603 indicating the application that created the electronic source document is displayed in a form superimposed on the thumbnail image.

In the example of FIG. 7, the thumbnail image 701 displays the first page of the constituent pages of the electronic-binder document, the thumbnail image 702 displays the second page of the constituent pages of the electronic-binder document, and the thumbnail image 703 displays the third page of the constituent pages of the electronic-binder document. Since the first and third pages of the electronic source document are pages that have been by the same application or pages that have been extracted from the same electronic source document, the application icons 701b, 703b displayed at the right of the thumbnail images 701 and 703 will be the same. On the other hand, since the application that created the second page of the electronic source document of thumbnail image 702 is different from that of the first and third pages, the application icon 702b, which is different from that of the first and third pages, is being displayed.

A specific example of processing in which a thumbnail of the second page of the electronic-binder document and the application icon of the application that created the electronic source document are displayed at steps S601 to S605 has been described.

Described next will be an example of processing in which the material-document name and page number of the second page of the electronic binder are displayed, as in the manner of a thumbnail image 802 in FIG. 8.

A cursor is moved over a thumbnail image at step S606, and it is determined at step S607 whether the position specified by the cursor falls within a predetermined area of the thumbnail image (e.g., below the thumbnail image). If the cursor is not within the predetermined area (“NO” at step S607), control returns to step S606. If the cursor is within the predetermined area (“YES” at step S607), control proceeds to step S608.

The document name (file name) of the electronic source document of the displayed page and the page number of the electronic source document are loaded and displayed at step S608. More specifically, the document name of the electronic source document of the displayed page and the page number of the electronic source document are obtained from the XML coding of the electronic-binder document exemplified in FIG. 2B. For example, in a case where the position indicated by the cursor is within the predetermined area of the thumbnail image 702 in FIG. 7, the line

<INDEX page=“2” idref=“ef0001” efilepage=“2”/>

within the tag <PAGEINDEX> is retrieved in the example of FIG. 2B. Here page=“2” indicates that this line is information regarding the second page of the electronic-binder document. From idref=“ef0001”, it can be found from analysis that the file of id=“ef0001” is an electronic source document. Further, efilepage=“2” indicates that the second page of he electronic-binder document is the second page of the electronic source document. Next, the line

<EFILEhref=“office¥ppt0000¥F_c01.ppt” composedpagefile=“pimg¥efile0001.pdf”type=“pdf” totalpage=“2”id=“ef0001”>

is retrieved. Here id=“ef0001” indicates that this line is information relating to the second page of the electronic source document of the electronic binder and that the file name of this electronic source document is “F_c01.ppt”.

Accordingly, it is ascertained that the file name of the second page of the electronic source document of the electronic binder is “F_c01.ppt” and that the second page has been selected as the constituent page of the electronic-binder document.

Next, at step S609, “DOCUMENT NAME: F_c01.ppt” and “PAGE NO. 2” of the second page of the electronic-binder document are displayed in a balloon 802a, as shown in the example of the display of thumbnail image 802 in FIG. 8. Similarly, a balloon 801a of thumbnail image 801 in FIG. 8 is an example in which the document name of the first page of the electronic source document of the electronic-binder document and the page number in the electronic source document are displayed, and a balloon 803a of thumbnail image 803 in FIG. 8 is an example in which the document name of the third page of the electronic source document of the electronic-binder document and the page number in the electronic source document are displayed.

As described above, according to this embodiment, a single generated electronic document is created from a plurality of kinds of electronic source documents. Under conditions in which thumbnail images corresponding to each of electronic source document pages constituting the generated electronic document are being displayed, information relating to the each of the electronic source document pages is displayed in accordance with an operation performed the user with respect to any of the thumbnail images. As a result, a user can readily ascertain information relating to each of the electronic source document pages without launching the application that created each of the electronic source document pages.

An information processing apparatus applicable to the above-described document management system of each embodiment of the present invention is shown in FIG. 22.

FIG. 22 is a block diagram showing the arrangement of the information processing apparatus applicable to the document management system of the present invention.

Referring to FIG. 22, a CPU 101 controls an entire information processing apparatus 1000 through a main bus 106 and also controls through an input I/F (interface) 104 an input device 110 (e.g., an image scanner, storage device, another information processing apparatus connected through a network line, or a facsimile apparatus connected through a telephone line) externally connected to the information processing apparatus 1000. The CPU 101 also controls through an output I/F (interface) 105 an output device 111 (e.g., a printer, monitor, another information processing apparatus connected through a network line, or a facsimile apparatus connected through a telephone line) externally connected to the information processing apparatus 1000. The CPU 101 executes a series of processing operations such as image input, image processing, color conversion processing, and image output control in accordance with an instruction input from an input section (e.g., a keyboard 112, pointing device 113, or pen 114) through a KBD I/F (keyboard interface) 107. The CPU 101 also controls through a video I/F (interface) 108 a display section 109 for displaying image data input from the input device 110 or image data created using the keyboard 112, pointing device 113, or pen 114.

A ROM 102 stores various control programs for executing various control operations of the CPU 101. An OS and control programs including a control program for implementing the present invention are loaded to a RAM 103 and executed by the CPU 101. The RAM 103 also functions as various work areas used to execute the control programs or temporary save area. In addition, a VRAM (not shown) for temporarily holding image data input from the input device 110 or image data created using the keyboard 112, pointing device 113, or pen 114 is constructed.

The present invention may be applied to either a system constituted by a plurality of devices (e.g., a host computer, an interface device, a reader, a printer, and the like) or an apparatus comprising a single device (e.g., a copying machine, a facsimile apparatus, or the like).

The object of the present invention is achieved even by supplying a storage medium which stores the program codes of software for implementing the functions of the above-described embodiments and causing the computer (or a CPU or MPU) of the system or apparatus to read out and execute the program codes stored in the storage medium.

In this case, the program codes read out from the storage medium implement the functions of the above-described embodiments by themselves, and the storage medium which stores the program codes constitutes the present invention.

As the storage medium for supplying the program codes, for example, a floppy disk, hard disk, optical disk, magnetooptical disk, CD-ROM, CD-R, magnetic tape, nonvolatile memory card, ROM, or the like can be used.

The functions of the above-described embodiments are implemented not only when the readout program codes are executed by the computer but also when the operating system (OS) running on the computer performs part or all of actual processing on the basis of the instructions of the program codes.

The functions of the above-described embodiments are also implemented when the program codes read out from the storage medium are written in the memory of a function expansion board inserted into the computer or a function expansion unit connected to the computer, and the CPU of the function expansion board or function expansion unit performs part or all of actual processing on the basis of the instructions of the program codes.

When the present invention is applied to the storage medium, it stores program codes corresponding to the above-described flow charts.

As many apparently widely different embodiments of the present invention can be made without departing from the spirit and scope thereof, it is to be understood that the invention is not limited to the specific embodiments thereof except as defined in the appended claims.

What is claimed is:

1. An information processing apparatus for composing an integrated electronic document composed of a plurality of kinds of electronic source documents, comprising:
holding means for holding the plurality of kinds of electronic source documents;
selection means for selecting one or more desired electronic source document pages from electronic source document pages of the plurality of kinds of electronic source documents held by said holding means;
composition means for composing the integrated electronic document on the basis of the electronic source document page selected by said selection means;
display means for displaying a thumbnail image that corresponds to the electronic source document page that constitutes the integrated electronic document composed by said composition means; and
display control means for displaying information, which relates to the electronic source document page that corresponds to the thumbnail image, in the vicinity of the thumbnail image based upon an operation with respect to the thumbnail image displayed by said display means.

2. The apparatus according to claim 1, wherein information relating to the electronic source document page is an icon image indicating an application that created the electronic source document page.

3. The apparatus according to claim 1, wherein information relating to the electronic source document page is a document name of the electronic source document that has the electronic source document page, or the number of pages of a electronic source document in said electronic source document.

4. The apparatus according to claim 1, wherein said display means displays a changeover designation unit for changing over display of thumbnail images page by page; and
said display control means displays information, which relates to the electronic source document page that corresponds to the thumbnail image, in the vicinity of the thumbnail image based upon an operation performed on said changeover designation unit.

5. The apparatus according to claim 1, wherein said display control means has determination means for determining whether the operation with respect to the thumbnail image displayed by said display means is being performed within a predetermined area;
the information relating to the electronic source document page that corresponds to the thumbnail image being displayed in the vicinity of the thumbnail image based upon the result of the determination by said determination means.

6. An information processing method for composing an integrated electronic document composed of a plurality of kinds of electronic source documents, comprising:
a holding step of holding the plurality of kinds of electronic source documents in a storage medium;
a selection step of selecting a desired electronic source document page from electronic source document pages of the plurality of kinds of electronic source documents held in the storage medium in the holding step;
a composition step of composing the integrated electronic document on the basis of the electronic source document page selected in the selection step;
a display step of displaying a thumbnail image that corresponds to the electronic source document page that constitutes the integrated electronic document composed at said composing step; and
a display control step of displaying information, which relates to the electronic source document page that corresponds to the thumbnail image, in the vicinity of the thumbnail image based upon an operation with respect to the thumbnail image displayed at said display step.

7. The method according to claim 6, wherein information relating to the electronic source document page is an icon image indicating an application that created the electronic source document page.

8. The method according to claim 6, wherein information relating to the electronic source document page is a document name of the electronic source document that has the electronic source document page, and the number of pages of individual pages of a electronic source document in said electronic source document.

9. The method according to claim 6, wherein said display step displays a changeover designation unit for changing over display of thumbnail images page by page; and
said display control step displays information, which relates to the electronic source document page that corresponds to the thumbnail image, in the vicinity of the thumbnail image based upon an operation performed on said changeover designation unit.

10. The method according to claim 6, wherein said display control step has a determination step of determining whether the operation with respect to the thumbnail image displayed at said display step is being performed within a predetermined area;
the information relating to the electronic source document page that corresponds to the thumbnail image being displayed in the vicinity of the thumbnail image based upon the result of the determination at said determination step.

11. A computer-readable memory which stores program codes of information processing for composing an integrated electronic document composed of a plurality of kinds of electronic source documents, comprising:
a program code of a holding step of holding the plurality of kinds of electronic source documents in a storage medium;
a program code of a selection step of selecting a desired electronic source document page from electronic source document pages of the plurality of kinds of electronic source documents held in the storage medium in the holding step;
a program code of a composition step of composing the integrated electronic document on the basis of the electronic source document page selected in the selection step;
a program code of a display step of displaying a thumbnail image that corresponds to the electronic source document page that constitutes the integrated electronic document composed at said composition step; and
a program code of a display control step of displaying information, which relates to the electronic source document page that corresponds to the thumbnail image, in the vicinity of the thumbnail image based upon an operation with respect to the thumbnail image displayed at said display step.
